(19) United States
(12) Patent Application Publication
(10) Pub. No.: US 2010/0030916 A1
(43) Pub. Date: Feb. 4, 2010

(54) METHOD AND SYSTEM FOR DISTRIBUTING CLOCK SIGNALS

(75) Inventor: Ian David Greenwood Graham, Manukau City (NZ)

Correspondence Address: FULBRIGHT & JAWORSKI, LLP, 666 FIFTH AVE, NEW YORK, NY, 10103-3198, US

(73) Assignee: Endace USA Limited

(21) Appl. No.: 12/535,422

(22) Filed: Aug. 4, 2009

Related U.S. Application Data
(60) Provisional application No. 61/137,978, filed on Aug. 4, 2008.

(51) Int. Cl. G06F 1/12; H04L 9/00

(52) U.S. Cl. 709/248; 380/274

(57) ABSTRACT

A system and method for distributing accurate time signals comprises a plurality of base stations distributed over an area and a plurality of time receivers. The plurality of base stations receive time signals from a GPS system and transmits time signal packets. The plurality of time receives time signal packets from one or more base stations. Each time receiver is located at or near a measurement point and is operable to estimate a corrected time by a triangulation process from a received time signal packet.

### RELATED APPLICATION

This application claims priority to U.S. Provisional Patent Application No. 61/137,978 filed on Aug. 4, 2008, which is incorporated herein in its entirety.

### BACKGROUND OF THE INVENTION

The invention relates to generating clock signals, more particularly to providing accurate synchronized clocks at multiple measurements points in different geographical locations.

In order to make accurate measurements of the transit time of network packets, or the latency of network elements, it is necessary to have very accurately synchronized clocks at measurement points in different geographic locations. In practice, the required clock synchronization accuracy is one microsecond or better.

Several methods of clock distribution exist, but each has its disadvantages in the context of clock distribution in urban areas.

GPS time receivers have sufficient accuracy, however the GPS receiver requires a clear view of the sky so that a number of satellites can be observed simultaneously. When a measurement point is located in the lower floors of a building it is often difficult or impossible to obtain access to the roof to install a GPS antenna, and to run cabling down from the roof to the measurement point.

Time distribution protocols that run over standard network cabling can be used to distribute a clock. The most commonly used is the Network Time Protocol (NTP). However, NTP in general is not capable of providing sufficient accuracy to measure transit time of network packets. The Precision Time Protocol (PTP, IEEE 1588) can achieve synchronization accuracy of better than one microsecond, but only over dedicated cabling in a small network, and thus cannot be used to distribute time between buildings. PTP therefore suffers from the limitation of requiring a GPS time receiver in the same building, and the same difficulties of access apply as with NTP.

Therefore, the claimed invention proceeds upon the desirability of providing a system for accurately distributing clock signals to measurement points located within buildings in an urban environment, without the disadvantages of the previous systems described herein.

### OBJECTS AND SUMMARY OF THE INVENTION

An object of the claimed invention is to provide a system and method for accurately distributing synchronized clock signals to a plurality of measurement points located in different geographic locations, e.g., within buildings in an urban environment.

In accordance with an exemplary embodiment of the claimed invention, a service provider can employ the claimed system to provide by establishing a network of base stations, e.g., in the central business district of a city. Customers can access the time service by purchasing or leasing one or more time receivers, and/or pay a fee to the service provider. It is appreciated that the service provider can offer various levels of services depending on the accuracy and reliability of the time service desired by the customers.

In accordance with an exemplary embodiment of the claimed invention, a system and method for distributing accurate time signals comprises a plurality of base stations distributed over an area and a plurality of time receivers. The plurality of base stations receives time signals from a GPS system and transmits time signal packets. The plurality of time receives time signal packets from one or more base stations. Each time receiver is located at or near a measurement point and is operable to estimate a corrected time by a triangulation process from a received time signal packet.

In accordance with an exemplary embodiment of the claimed invention, the system can be used in a commercial application where the company offering the time service sets up a network of base stations in, for example, the central business district of a large city. Customers wanting to access the time service can purchase or lease one or more time receivers, and can pay a fee for the time service. It is appreciated that various service levels can be offered depending on the accuracy and reliability of the time service.

Various other objects, advantages and features of the claimed invention will become readily apparent from the ensuing detailed description, and the novel features will be particularly pointed out in the appended claims.

### BRIEF DESCRIPTION OF THE DRAWINGS

The following detailed description, given by way of example, and not intended to limit the claimed invention solely thereto, will best be understood in conjunction with the accompanying drawings in which:

FIG. 1 is a block diagram of a system in accordance with an exemplary embodiment of the claimed invention;

FIG. 2 is a block diagram of a base station 200 in accordance with an exemplary embodiment of the claimed invention; and

FIG. 3 is a block diagram of the radio time receiver 100 located at a measurement point in accordance with an exemplary embodiment of the claimed invention.

### DETAILED DESCRIPTION OF THE EMBODIMENTS

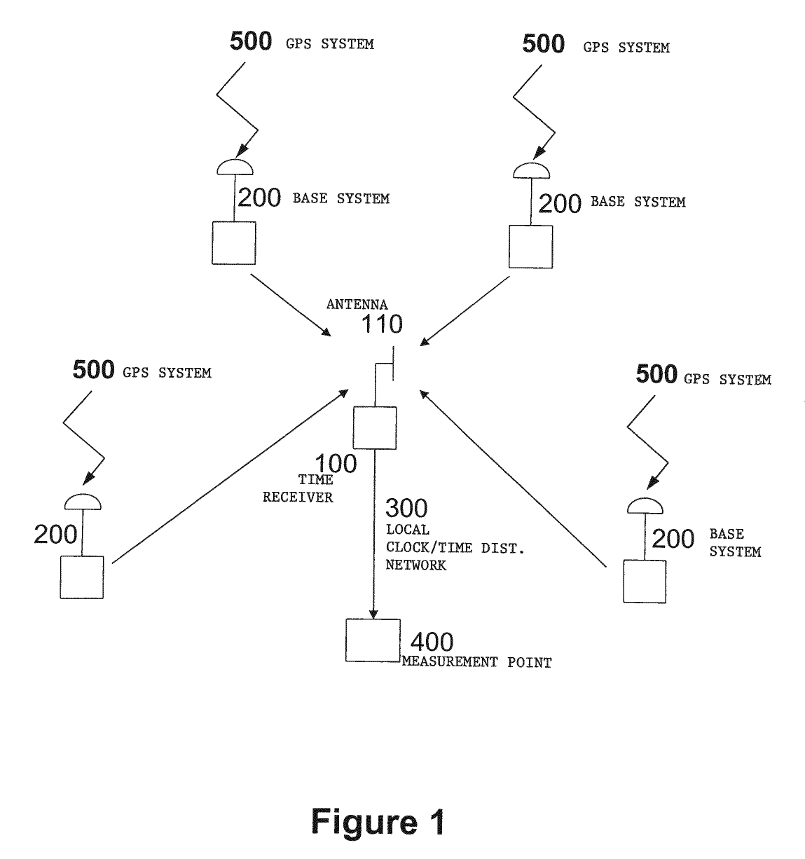

In an accordance with an exemplary embodiment of the claimed invention, as shown in FIG. 1, the system comprises a number of base stations (200) distributed over an area, which communicate with radio time receivers (100) located at or near each required measurement point. The time receiver (100) receives signals at its antenna (110) from a number of base stations (200), which in turn receive accurate timing from a GPS system (500). In accordance with an aspect of the claimed invention, a radio time receiver (100) can be connected to a local time distribution network (300), which provides clock synchronization to several measurement points (400) located close to each other, such as in the same laboratory or building.

The base stations (200) receives time and position information from the GPS system (500). in accordance with an exemplary embodiment of the claimed invention, each base station (200), at predetermined intervals, sends out time packets from its radio sub-system. The time receiver (100) receives such packets from one or more base stations (200). Upon receipt of the time packets, the time receiver (100) estimates the correct time as accurately as possible by taking into account its position relative to the base stations (200) and the calculated time of flight of packets from base station (200) to the time receiver (100). This process is referred to herein as a triangulation process.

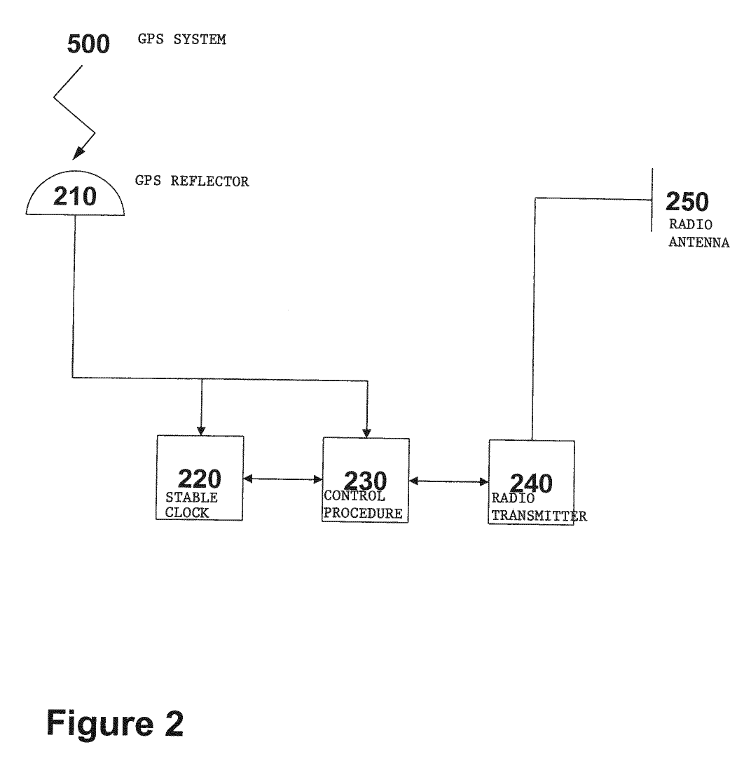

Turning now to FIG. 2, there is illustrated a block diagram of the base station (200) in accordance with an exemplary embodiment of the claimed invention. A GPS time receiver (210) receives signals from the GPS system (500), and transmits time data to a stable clock (220), and time and position data to a control processor (230). The control processor (230) manages the stable clock (220) and uses the output from the stable clock (220) to drive a radio transmitter (240), which has an antenna (250). In accordance with an exemplary embodiment of the claimed invention, as shown in FIG. 2, the base station (200) comprises five major elements:
1. One or more GPS antennas and GPS receivers (210), which receive signals from the GPS constellation or system (500);
2. A stable clock source (220) that can be conditioned by the GPS time signals;
3. A control processor (230);
4. One or more radio transmitters (240); and
5. One or more radio antennas (250).

Each base station (200) requires at least one GPS receiver (210). However, additional GPS time receivers (210) can be used in the base station (200) to provide redundancy against receiver failure, to allow the detection of natural or deliberate interference on GPS frequencies, and to enable an estimate of the time accuracy provided by the GPS receivers (210).

In addition to the time measurement, the GPS receivers (210) provide an accurate geographic position to the control processor (230). Preferably, this geographic positional information is used as an input to the triangulation process.

Further, the time signals from the GPS receivers (210) can be used to condition a local stable clock (220). In accordance with an exemplary embodiment of the claimed invention, the local stable clock (220) can be implemented in a technology that has a naturally slow drift rate, so that only occasional corrections from the GPS system (500) are needed to maintain its accuracy within the required limits. Thus, the local stable clock can advantageously maintain its accuracy even if there are interruptions to the GPS time signals, such as might be caused by interference or adverse weather conditions. It is appreciated that this local stable clock (220) of the base station (200) can be implemented in a number of different ways, including temperature compensated or stabilized crystal oscillators, or atomic clocks.

In accordance with an exemplary embodiment of the claimed invention, the control processor (230) has the following principal functions:
1. To provide overall control of the base station (200);
2. To receive time signals and supervise the local clock(s) (220);
3. To receive the geographic position from the GPS receiver(s) (210);
4. To estimate time accuracy from the received time signals and the known stability of the clock(s);
5. To format periodic time packets and pass these to the radio transmitter(s) (240);
6. To communicate with remote management systems which allow the status of the base station to be controlled and monitored from a remote point; and
7. To maintain an operational log of the base station's and its functions.

In accordance with an exemplary embodiment of the claimed invention, the control processor (230) can be implemented using a single board or other microprocessor system running a standard operating system, with special purpose hardware to receive time signals and to communicate with the radio transmitter (240). Preferably, the control processor (230) can be connected to a local or wide-area network for management purposes. This connection can be wired or wireless using any known or available methods.

At predetermined intervals, the control processor (230) formats a time signal packet and forwards the formatted time signal packet to the transmitter (240). In accordance with an exemplary embodiment of the claimed invention, the time signal packet comprises at least one or more of the following:
1. A time and date stamp derived from the local clock (220);
2. The position of the base station (200);
3. Indicators of the quality of the time and position information;
4. Correction information for antenna position; and
5. Other management information.

Preferably, the time signal packet can be encrypted to inhibit spoofing or unauthorized use of the time service of the claimed invention. In accordance with an exemplary embodiment of the claimed invention, the time signal packet contains coding to enable the time receiver (210) to make an accurate measurement of the time signal packet's time of arrival.

In order to minimize interference from similar base stations, in accordance with an exemplary embodiment of the claimed invention, the base station (200) can transmit the time signal packets at irregular or random times, where each base station (200) has a different pattern of transmission times.

Each base station (200) requires at least one radio transmitter (240). In accordance with an exemplary embodiment of the claimed invention, the radio transmitter (240) operates on frequencies that are capable of penetrating buildings. The radio transmitter (240) can be narrow band, or use spread spectrum techniques. Preferably, the radio transmitter (240) can be frequency-agile to avoid natural or deliberate interference, or interference caused by simultaneous transmissions from other similar base stations.

In accordance with an exemplary embodiment of the claimed invention, each radio transmitter (240) can feed one or more radio antennas (250). In accordance with an aspect of the claimed invention, the time packet transmitted by the base station (200) contains information to enable the receiver (100) to correct the received time as a function of the relative position of the base station (200) and the receiver's antenna (110).

In accordance with an exemplary embodiment of the claimed invention, the base station (200) can have the facility to communicate with one or more remote management systems. The remote management system enables the remote management of a plurality of base stations (200). The remote management functions can include, but is not limited to the following:
1. Starting, stopping and rebooting the base stations (200);
2. Receiving error and other indications from the base stations (200);
3. Monitoring the physical security of the base stations (200); and
4. Receiving estimates of time accuracy of each base station (200).

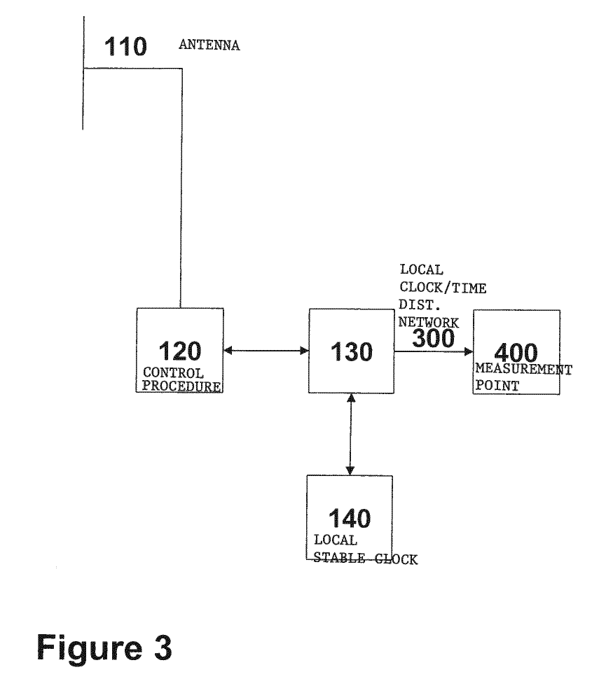

Turning now to FIG. 3, there is illustrated a block diagram of the radio time receiver (100) located at a measurement point (400). The radio time receiver's antenna (110) receives signals from one or more base stations (200) which are interpreted in the radio receiver (120). The output of the radio receiver is used by the control processor (120) to condition a local stable clock (140). The control processor (130) can then distribute the local clock over various types of local clock distribution networks (300) to other measurement points (400).

In accordance with an exemplary embodiment of the claimed invention, the radio time receiver (100) comprises at least the following elements:
1. One or more radio antenna (110);
2. One or more radio receivers (120);
3. A control processor (130);
4. A local stable clock (140);
5. A local time distribution system (300); and
6. A management console and/or network connection.

The radio subsystem of receivers (120) and antenna (110) receive time signal packets from one or more base stations (200). In accordance with an exemplary embodiment of the claimed invention, the control processor (130) of the radio time receiver (100) has including but not limited to the following functions:
1. Control of all system elements;
2. Receiving time packets from the radio sub-system;
3. Time stamping received packets using the local stable clock;
4. Decrypting time packets and extracting time, position and management information;
5. Computing the best estimate of the error of the local stable clock and applying clock correction as necessary;
6. Distributing time referred to the local stable clock by one of several possible well-known time distribution methods;
7. Enforcing usage policies; and
8. Providing a user interface to report on the functioning of the time distribution system (300).

When a time signal packet is received, the control processor (130) of the radio time receiver (100) time stamps the received time signal packet using the local clock (140), and decrypts the received time signal packet to extract the time, position and management information. In accordance with an exemplary embodiment of the claimed invention, the control processor (130) of the radio time receiver (100) can correct the time stamp for several factors, including but not limited to the following:
1. The local latency from antenna (110) through the receiver (100) to the control processor (130);
2. The latency from the base station's control processor (230) through radio transmitter (240) and antenna (240) (determinable from data included in the time packet);
3. The time of flight from base station (200) to receiver (100), whether the receiver position is accurately known or is obtained by triangulation using time packets from several base stations (200).

The corrected time stamp then provides an estimate of the time, by the local stable clock (120), as to when the received time signal packet was generated at the base station (200). In accordance with an exemplary embodiment of the claimed invention, the difference between the corrected time stamp and the time stamp contained in the time signal packet provides an estimate of the error of the local clock. Preferably, the system and method of the claimed invention combines one or more of these error estimates to provide value to be used to correct the local clock, and a measure of confidence in the correction value. If the confidence value is sufficiently high or above a predetermined threshold, the control processor (130) can apply that correction to the local clock, thus bringing it into better coincidence or sync with base station time, which is ultimately derived from the GPS system (500).

Similar to the local stable clock of the base station (200), it is appreciated that the local stable clock of the radio time receiver (100) can be implemented using one of a number of well-known technologies, including temperature controlled and/or compensated crystal oscillators and atomic clocks.

The required stability of the local clock depends on the required time accuracy of the system, and maximum time between clock corrections. For example, if the required time accuracy is 1 microsecond and the maximum time between corrections is one second, then the maximum drift of the clock in one second should be less than 1 part in a million.

If longer intervals between corrections are possible, such as might occur due to interference or adverse radio propagation conditions, the stability will have to be higher. For example, if the required time accuracy is 1 microsecond and the maximum time between corrections is one hour, then the local clock should drift less than one microsecond in an hour.

The control processor (130) of the radio time receiver (100) can distribute the local clock value by a number of well-known technologies, including but not limited to PTP, NTP, 1 pulse per second (pps) and Inter Range Instrumentation Group (IRIG). In accordance with an exemplary embodiment of the claimed invention, the control processor (130) can also provide a user interface accessible either locally or over a network. The user interface can be access management information, such as the quality of the time synchronization to GPS via the base stations (200). It is appreciated that the user interface can be accessed through a web browser, command line interface, simple network management protocol (SNMP) or similar well-known technology in accordance with an aspect of the claimed invention.

In accordance with an exemplary commercial implementation of the claimed invention, a time service operator can set up a network of base stations (200), for example in the central business district of a large city. The time service operator maintains the network of base stations (200), and ensures that correct time signals are being transmitted by continuously monitoring the status of each base station (200) in the network of base stations (200).

A customer of the time service, requiring accurate time at one or more measurement points, can purchase or lease one or more radio time receivers (100), and/or pay a periodic fee, such as monthly or quarterly, for the time service provided by the time service operator. Each time receiver (100) can service a number of measurement points within the reach of the local time distribution network (300).

The customer can then use the accurate time distributed by the time receivers (100) to synchronize the measurement devices at various measurements points distributed through the customer's computer networks. This advantageously enables the customer to accurately measure network packet delay and the latency of data in the customer's computer network. It is appreciated that the customer can also utilize the accurate time provided by the claimed invention for any application which require synchronization of separate points and such use is within the contemplation of the claimed invention.

While the claimed invention has been particularly described with respect to the illustrated embodiment, it will be appreciated that various alterations, modifications and adaptations maybe made based on the present disclosure, and are intended to be within the scope of the claimed invention. It is intended that the appended claims be interpreted as including the embodiment discussed above, those various alternatives which have been described and all equivalents thereto.

What is claimed is:

1. A system for distributing accurate time signals, comprising:
a plurality of base stations distributed over an area for receiving time signals from a GPS system and transmitting time signal packets; and
a plurality of time receivers for receiving time signal packets from one or more base stations, each time receiver located at or near a measurement point and operable to estimate a corrected time by a triangulation process from a received time signal packet.

2. The system of claim 1, wherein each base station comprises:
a radio transmitter with an antenna;
a GPS time receiver for receiving signals from said GPS system;
a local stable clock for receiving time data from said GPS time receiver; and
a control processor for receiving time and position data from said GPS time receiver and using an output of said local stable clock to drive said radio transmitter.

3. The system of claim 2, wherein GPS time receiver is operable to provide geographic position to said control processor; and wherein said geographic position is an input to said triangulation process to estimate said corrected time.

3. The system of claim 2, wherein said GPS time receiver is operable to condition said local stable clock.

4. The system of claim 2, wherein said stable clock has a slow drift rate.

5. The system of claim 4, wherein said local stable clock is one of the following: a temperature compensated or stabilized crystal oscillator or atomic clock.

6. The system of claim 2, wherein said each base station comprises one or more additional GPS time receiver to provide or enable one or more of the following: redundancy against GPS time receiver failures, detection of natural or deliberate interference on GPS frequencies or an estimate of time accuracy provided by GPS time receivers.

7. The system of claim 2, wherein said control processor is operable to provide one or more of the following functions: overall control of a base station associated with said control processor; receiving timing signals and supervising said local stable clock; receiving geographic position from said GPS time receiver; estimating time accuracy from said received time signals; formatting said time signal packets; transmitting said time signal packets to said radio transmitter; communicating with remote management system which is operable to control and monitor status of said base station associated with said control processor from a remote point; and maintaining an operational log.

8. The system of claim 7, wherein said control processor is connected to a local wide-area network for management purposes.

9. The system of claim 7, wherein said control processor is operable to support one or more of the following remote management functions: starting, stopping or rebooting said each base station associated with said control processor; receiving error and status indications from said each base station associated with said control processor; monitoring security of said each base station associated with said control processor; and receiving estimates time accuracy of said each base station associated with said control processor.

10. The system of claim 7, wherein, at predetermined intervals, said control processor is operable to format a time signal packet and transmit the formatted time signal packet to said radio transmitter.

11. The system of claim 2, wherein said GPS time receiver comprises an antenna; and wherein each of said time signal packet comprises at least one or more of the following: a time and date stamp derived from said local stable clock; said position data of said each base station; indicators of quality of said time and position data; correction information for an antenna position of said GPS time receiver; and management information.

12. The system of claim 2, wherein said control processor is operable to encrypt said time signal packets.

13. The system of claim 1, wherein said plurality of base stations are operable to transmit said time signal packets periodically.

14. The system of claim 1, wherein said plurality of base stations are operable to transmit said time signal packets at irregular or random times such that each base station has a different pattern of transmission times.

15. The system of claim 2, wherein said radio transmitter operates in frequencies capable of penetrating buildings.

16. The system of claim 15, wherein said radio transmitter is operable to employ a narrow band or spread spectrum to transmit said time signal packets.

17. The system of claim 15, wherein said radio transmitter of said each base station is frequency-agile to avoid natural interference, deliberate interference or interference caused by simultaneous transmission from said radio transmitter of other base station.

18. The system of claim 1, wherein each time signal packet comprises coding information; and wherein said plurality of time receivers is operable to determine an arrival time of said each time signal packet.

19. The system of claim 1, wherein each time receiver comprises:
a radio receiver with an antenna for receiving said time signal packets from one or more base stations;
a local stable clock; and
a control processor for conditioning said local stable clock and distributing time of said local stable clock.

20. The system of claim 19, further comprising a local time distribution system; and wherein said control processor is operable to distribute said time of said local stable clock over said local time distribution system.

21. The system of claim 19, wherein said control processor is operable to provide one or more of the following functions: overall control of said each time receiver associated with said control processor; receiving time packets from said radio receiver; time stamping received time signal packets using said time of said local stable clock; decrypting encrypted time packets; extracting time, position and management information from said time signal packets; computing an estimate of error of said local stable clock; correcting said local stable clock based on said estimate of error; enforcing usage policies; and supporting user interface to provide information relating to operation and function of said system.

22. The system of claim 21, wherein said control processor is operable to time stamp each received time signal packet using said local stable clock.

23. The system of claim 22, wherein said control processor is operable to correct the time stamp of said each received time signal packet to provide a corrected time stamp by accounting for a local latency from said radio receiver's antenna to said control processor; latency from a control processor of a base station which transmitted said each received time signal packet through an antenna of a radio transmitter of said base station from said each received time signal packet; and transmission time from said base station to said each time receiver associated with said control processor.

24. The system of claim 23, wherein said control processor is operable to determine said transmission time by triangulation process using time signal packets from two or more base stations.

25. The system of claim 23, wherein said control processor is operable to determine said estimate of said error from said corrected time stamp and a time stamp contained in said each time signal packet.

26. The system of claim 25, wherein said control processor is operable to correct said local stable clock based on said estimate of said error if a confidence value of said estimate is above a predetermined threshold.

27. The system of claim 19, wherein said stable clock has a slow drift rate.

28. The system of claim 27, wherein said local stable clock is one of the following:
a temperature compensated or stabilized crystal oscillator or atomic clock.

29. A method for distributing accurate time signals, comprising the steps of:
receiving time signals from a GPS system by a plurality of base stations distributed over an area;
transmitting time signal packets by said plurality of base stations; and
receiving time signal packets from one or more base stations by a plurality of time receivers, each time receiver located at or near a measurement point and operable to estimate a corrected time by a triangulation process from a received time signal packet.
